(19) United States
(12) Patent Application Publication
(10) Pub. No.: US 2026/0039097 A1
(43) Pub. Date: Feb. 5, 2026

(54) POWER FEEDING SYSTEM AND INTERRUPTION CONTROL METHOD

(71) Applicant: NTT Inc., Tokyo (JP)

(72) Inventors: Yuji HIGUCHI, Tokyo (JP); Toru TANAKA, Tokyo (JP); Naomichi NAKAMURA, Tokyo (JP); Naoki HANAOKA, Tokyo (JP)

(21) Appl. No.: 19/119,236

(22) PCT Filed: Nov. 7, 2022
(86) PCT No.: PCT/JP2022/041313

§ 371 Date: Apr. 8, 2025

(51) Int. Cl. H02B 7/06

(52) U.S. Cl. CPC H02B 7/06

(57) ABSTRACT

An object of the present disclosure is to suppress the manufacturing cost of a circuit breaker of a power feeding system and to achieve a relatively small size.

Therefore, the present disclosure provides a power feeding system including a first circuit breaker, a second circuit breaker, and a control terminal that remotely controls the first circuit breaker and the second circuit breaker, wherein the control terminal transmits an opening signal indicating opening of the first circuit breaker to the first circuit breaker and the second circuit breaker, the first circuit breaker waits for a lapse of a first time on the basis of the opening signal, the second circuit breaker changes a setting to suppress an opening operation of the second circuit breaker during the first time on the basis of the opening signal and waits for a lapse of a second time, the first circuit breaker opens an electric path of the first circuit breaker during the second time, and the second circuit breaker restores the changed setting after the second time elapses.

### TECHNICAL FIELD

The present disclosure relates to a power feeding system, and relates to a technique for preventing malfunction due to an opening/closing noise of a circuit breaker.

### BACKGROUND ART

A conventional direct current cutoff system is a combination of independent unidirectional direct current circuit breakers, and there is a possibility that a noise generated when one of the plurality of direct current circuit breakers operates causes another circuit breaker to malfunction. Therefore, countermeasures against noise have been implemented by incorporation of a filter that reduces noise (common normal choke, common choke) in a circuit breaker (Non Patent Literature 1).

### CITATION LIST

### Non Patent Literature

Non Patent Literature 1: Chokuryu kyuden system ni-okeru shadanki no noise tokusei (in Japanese) (Noise characteristics of a circuit breaker in a direct current power feeding system) <https://www.jstage.jst.go.jp/article/jceeek/2008/0/2008_0_491/pdf>

### Patent Literature

Patent Literature 1: JP 2008-288845 A

### SUMMARY OF INVENTION

### Technical Problem

However, in a case where a filter that physically reduces noise is added to a circuit breaker as in the conventional technique, it is necessary to add and modify hardware, and thus, there is a problem that the manufacturing cost of the circuit breaker increases and downsizing of the circuit breaker is difficult.

The present invention has been made to solve the above-described problem, and an object of the present invention is to suppress the manufacturing cost of a circuit breaker and to achieve a relatively small size.

### Solution to Problem

In order to solve the above problem, an invention according to claim 1 is a power feeding system including a first circuit breaker, a second circuit breaker, and a control terminal that remotely controls the first circuit breaker and the second circuit breaker, wherein the control terminal transmits an opening signal indicating opening of the first circuit breaker to the first circuit breaker and the second circuit breaker, the first circuit breaker waits for a lapse of a first time on the basis of the opening signal, the second circuit breaker changes a setting to suppress an opening operation of the second circuit breaker during the first time on the basis of the opening signal and waits for a lapse of a second time, the first circuit breaker opens an electric path of the first circuit breaker during the second time, and the second circuit breaker restores the changed setting after the second time elapses.

### Advantageous Effects of Invention

As described above, according to the present invention, it is possible to suppress the manufacturing cost of a circuit breaker and achieve a relatively small size.

### BRIEF DESCRIPTION OF DRAWINGS

FIG. 1 is an overall configuration diagram of a power feeding system of the present embodiments.

FIG. 2 is a configuration diagram of a control terminal and each circuit breaker in the power feeding system of the present embodiments.

FIG. 3 is a sequence diagram illustrating an operation of each circuit breaker in a case where an electric path of a circuit breaker 5b is opened on the basis of a signal from a control terminal according to the first embodiment.

FIG. 4 is a conceptual diagram illustrating a situation in which supply of a current to a building B is cut off according to the first embodiment.

FIG. 5 is a diagram illustrating a setting change example of a control unit.

FIG. 6 is a sequence diagram illustrating an operation of each circuit breaker in a case where an electric path of a circuit breaker 5c is closed on the basis of a signal from the control terminal according to the second embodiment.

FIG. 7 is a conceptual diagram illustrating a situation in which supply of a current to a building C is started according to the second embodiment.

FIG. 8 is a sequence diagram illustrating operations of a circuit breaker 5a and other circuit breakers in a case where an electric path of the circuit breaker 5a is opened according to the third embodiment.

FIG. 9 is a conceptual diagram illustrating a situation in which a short circuit occurs in a branch line 6a connected to a building A and supply of a current to the building A is stopped according to the third embodiment.

### DESCRIPTION OF EMBODIMENTS

Hereinafter, embodiments of the present invention will be described with reference to the drawings.

### System Configuration of Embodiments

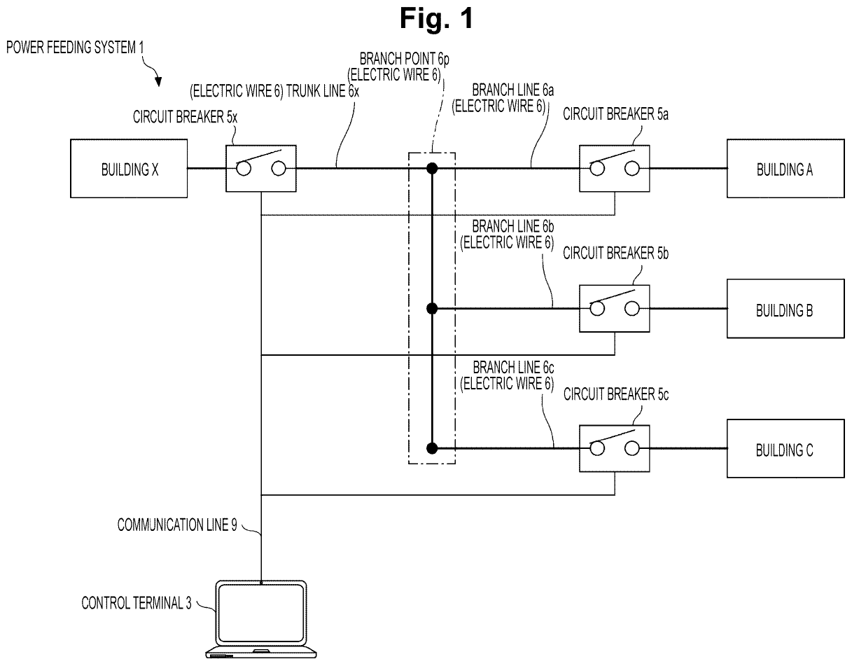

First, an overall configuration of a power feeding system 1 of the present embodiments will be described with reference to FIG. 1. FIG. 1 is an overall configuration diagram of the power feeding system according to the present embodiments.

As illustrated in FIG. 1, the power feeding system 1 of the present embodiments is constructed by a control terminal 3 and a plurality of circuit breakers 5a, 5b, 5c, and 5x. Note that the circuit breakers 5a, 5b, 5c, and 5x are collectively referred to as “circuit breakers 5”.

As illustrated in FIG. 1, an electric wire 6 is connected from a building X as a power feeding source to each of buildings A, B, and C as power feeding destinations. The electric wire 6 includes a trunk line 6x on the building X side and respective branch lines 6a, 6b, and 6c on the buildings A, B, and C sides. In addition, the branch lines 6a, 6b, and 6c branch in parallel from a branch point 6p.

The circuit breaker 5x is provided in a portion of the trunk line 6x, and can cut off a current supplied from the building X. The circuit breaker 5a is provided in a portion of the branch line 6a, and can cut off a current supplied to the building A. The circuit breaker 5b is provided in a portion of the branch line 6b, and can cut off a current supplied to the building B. The circuit breaker 5c is provided in a portion of the branch line 6c, and can cut off a current supplied to the building C. In FIG. 1, three circuit breakers 5a, 5b, and 5c are illustrated on the supply destination side, but the number of circuit breakers may be four or more as long as the number of circuit breakers is two or more.

The control terminal 3 and the circuit breakers 5 can communicate via a communication line 9. Note that communication may be performed by wireless communication instead of the communication line 9. The communication line 9 is an example of communication networks, and the communication networks include the Internet, a local area network (LAN), and the like. A part of the communication networks may perform wireless communication.

The control terminal 3 includes one or a plurality of computers. In a case where the control terminal 3 includes a plurality of computers, the control terminal 3 may be referred to as a “control terminal” or a “control system”. The control terminal 3 is managed and used by a user. The control terminal 3 can remotely control the circuit breakers 5 via the communication line 9.

### Each Configuration of System

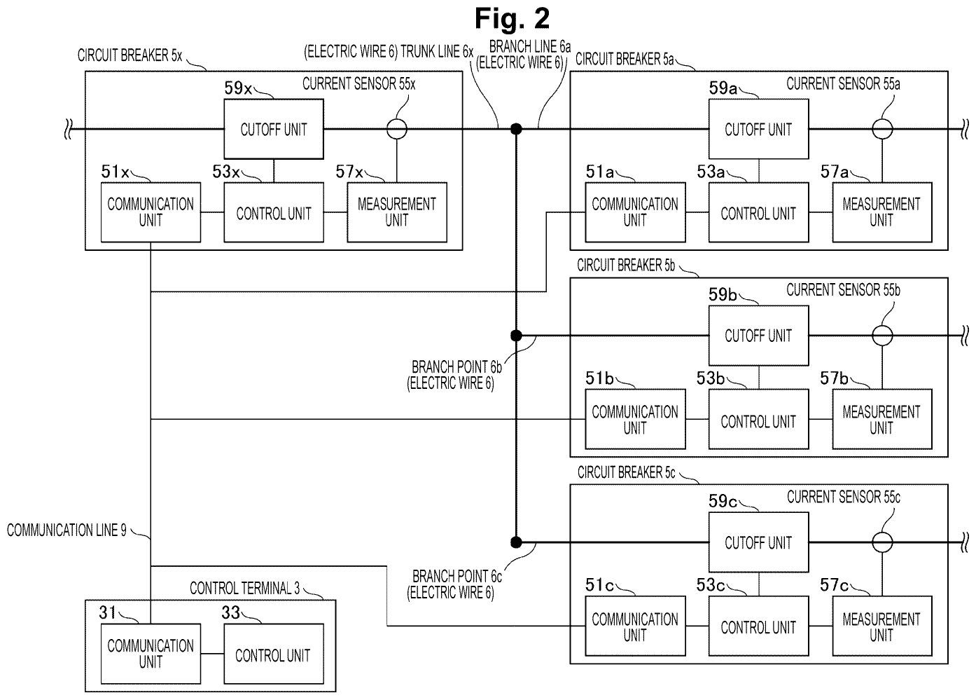

Next, configurations of the control terminal and each circuit breaker in the power feeding system of the present embodiments will be described with reference to FIG. 2. FIG. 2 is a configuration diagram of the control terminal and each circuit breaker in the power feeding system of the present embodiments.

### Configuration of Control Terminal

As illustrated in FIG. 2, the control terminal 3 includes a communication unit 31 and a control unit 33.

The communication unit 31 communicates with the circuit breakers 5 via the communication line 9.

The control unit 33 includes a central processing unit (CPU), a read only memory (ROM), a random access memory (RAM) 303, and a solid state drive (SSD), and remotely controls the circuit breakers 5. Note that a hard disk drive (HDD) may be used instead of the SSD.

### Configuration of Circuit Breaker

Each of the circuit breakers 5 can cut off bidirectional currents, and can change setting values (a cutoff threshold, an operation time limit, and validation or invalidation of a cutoff operation) of the circuit breaker 5 depending on the magnitude and direction of a current.

Therefore, as illustrated in FIG. 2, the circuit breaker 5x includes a communication unit 51x, a control unit 53x, a current sensor 55x, a measurement unit 57x, and a cutoff unit 59x.

Among these, the communication unit 51x can communicate with the control terminal 3 and the other circuit breakers 5 (here, the circuit breakers other than the circuit breaker 5x) by signals via the communication line 9. When an opening signal or a closing signal of a circuit breaker is received from another circuit breaker 5 (here, a circuit breaker other than the circuit breaker 5x) or the control terminal 3, the communication unit 51x outputs the opening signal or the closing signal to the control unit 53x. In addition, when an opening signal or a closing signal of a circuit breaker is input from the control unit 53x, the communication unit 51x transmits the opening signal or the closing signal of the circuit breaker to the other circuit breakers 5 (here, the circuit breakers other than the circuit breaker 5x).

The control unit 53x determines opening (OFF) or closing (ON) of each of the circuit breakers 5 on the basis of an opening signal or a closing signal of a circuit breaker input from the communication unit 51x or the measurement unit 57x, and outputs the opening signal or the closing signal of the circuit breaker to the communication unit 51x and the cutoff unit 59x. In addition, when an opening signal or a closing signal of a circuit breaker of the other circuit breakers 5 (here, the circuit breakers other than the circuit breaker 5x) is received from the communication unit 51x, the control unit 53x changes settings related to its own opening operation.

The current sensor 55x outputs a signal proportional to a current value of an electric path on which the circuit breaker 5x is installed to the measurement unit 57x.

The measurement unit 57x receives an input of the signal proportional to the current from the current sensor 55x, and outputs an opening signal or a closing signal of a circuit breaker to the control unit 53x.

The cutoff unit 59x is a circuit that opens and closes an electric line, and opens (OFF) the electric path (contact point) of the electric wire 6 according to an opening signal from the control unit 53x and closes (ON) the electric path (contact point) of the electric wire 6 according to a closing signal from the control unit 53x.

In addition, similarly, the circuit breaker 5a includes a communication unit 51a, a control unit 53a, a current sensor 55a, a measurement unit 57a, and a cutoff unit 59a. The circuit breaker 5b includes a communication unit 51b, a control unit 53b, a current sensor 55b, a measurement unit 57b, and a cutoff unit 59b. The circuit breaker 5c includes a communication unit 51c, a control unit 53c, a current sensor 55c, a measurement unit 57c, and a cutoff unit 59c.

The communication units 51a, 51b, and 51c, the control units 53a, 53b, and 53c, the current sensors 55a, 55b, and 55c, the measurement units 57a, 57b, and 57c, and the cutoff units 59a, 59b, and 59c have configurations similar to those of the communication unit 51x, the control unit 53x, the current sensor 55x, the measurement unit 57x, and the cutoff unit 59x, respectively, and thus the description thereof will be omitted.

### Processing or Operation of Embodiments

Next, processing or operation of the present embodiments will be described.

### First Embodiment

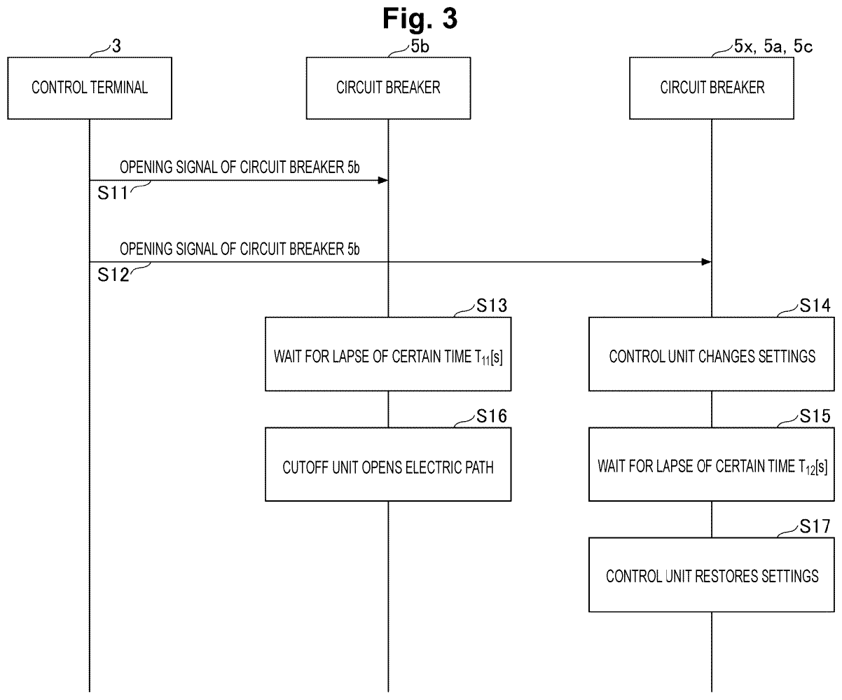

First, opening of the circuit breaker 5b will be described with reference to FIGS. 3 to 5.

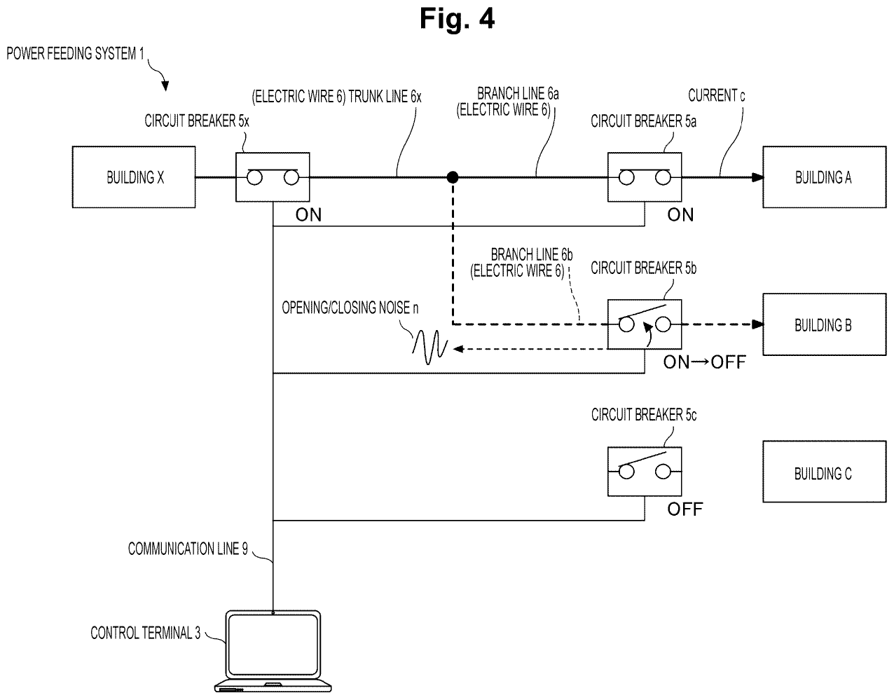

FIG. 3 is a sequence diagram illustrating an operation of each circuit breaker in a case where an electric path of the circuit breaker 5b is opened on the basis of a signal from the control terminal according to the first embodiment. FIG. 4 is a conceptual diagram illustrating a situation in which supply of a current to the building B is cut off according to the first embodiment. Note that, in the initial state, as illustrated in FIG. 4, the circuit breakers 5x, 5a, and 5b are in the closed state, and the circuit breaker 5c is in the open state.

S11: The communication unit 31 of the control terminal 3 transmits an opening signal indicating opening of the circuit breaker 5b (an example of a first circuit breaker) to the circuit breaker 5b via the communication line 9 in response to a command from the control unit 33. As a result, the communication unit 51b receives the opening signal indicating opening of the circuit breaker 5b.

S12: The communication unit 31 of the control terminal 3 transmits an opening signal indicating opening of the circuit breaker 5b to the circuit breakers 5x, 5a, and 5c (examples of a second circuit breaker) via the communication line 9 in response to a command from the control unit 33. As a result, each of the communication units 51x, 51a, and 51c receives the opening signal indicating opening of the circuit breaker 5b.

S13: In the circuit breaker 5b, the control unit 53b receives the opening signal indicating opening of the circuit breaker 5b from the communication unit 51b, and waits for the lapse of a certain time T₁₁[s].

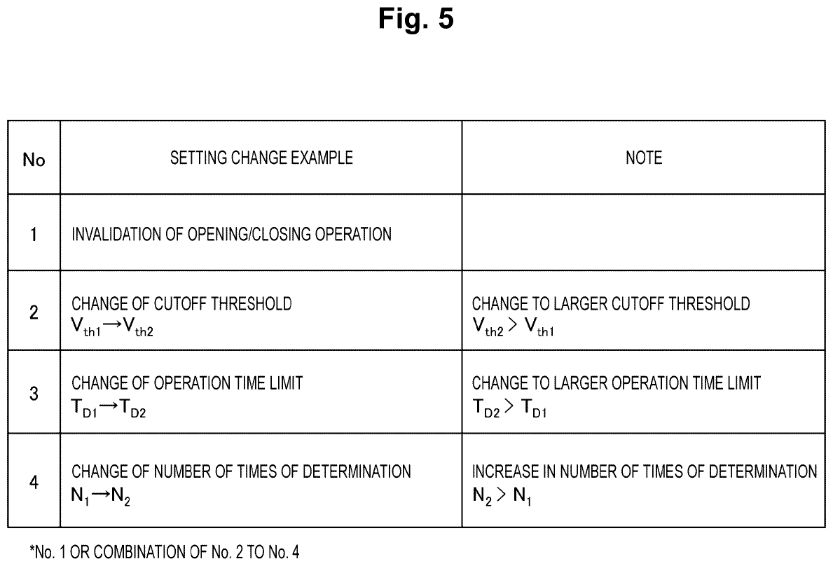

S14: In the circuit breaker 5x, the control unit 53x receives the opening signal indicating opening of the circuit breaker 5b from the communication unit 51x, and changes settings related to an opening operation of the circuit breaker 5x during the certain time T₁₁[s]. As a result, the circuit breaker 5x prepares for an opening/closing noise n of the circuit breaker 5b. FIG. 5 is a diagram illustrating a setting change example of a control unit. As illustrated in FIG. 5, the control unit 53x invalidates the opening operation by the cutoff unit 59x. Alternatively, even if the opening operation is not invalidated, the control unit 53x makes it difficult to perform opening by changing the cutoff threshold to a larger value, changing the operation time limit to a larger value, and changing the number of times of determination to increase the number. That is, in FIG. 5, the control unit 53x changes the settings to suppress the opening operation of the circuit breaker 5x by changing the settings of No. 1 or a combination of No. 2 to No. 4. Note that the circuit breakers 5a and 5c also perform operation similar to that of the circuit breaker 5x to prepare for the opening/closing noise n of the circuit breaker 5b.

Note that, when the cutoff threshold is increased, the control unit 53x makes it difficult for the cutoff unit 59x to perform the opening operation. When the operation time limit is increased, the control unit 53x makes it difficult for the cutoff unit 59x to perform the opening operation. When the number of times of determination is increased, the control unit 53x increases the number of times of determination of opening (OFF) or closing (ON) of each of the circuit breakers 5 on the basis of an opening signal or a closing signal of a circuit breaker input from the measurement unit 57x, and more quickly determines the situation.

S15: Each of the circuit breakers 5x, 5a, and 5c waits for the lapse of a certain time T₁₂[s].

S16: In the circuit breaker 5b, during the certain time T₁₂[s], the cutoff unit 59b opens (OFF) the electric path (contact point) of the branch line 6b in response to the opening signal from the control unit 53b. As a result, as illustrated in FIG. 4, although the opening/closing noise n is generated in the circuit breaker 5b, it is possible to prevent the other circuit breakers 5x, 5a, and 5c from malfunctioning.

S17: In the circuit breaker 5x, the control unit 53x restores the changed settings illustrated in FIG. 5 after the certain time T₁₂[s] elapses. In addition, the circuit breakers 5a and 5c also perform operation similar to that of the circuit breaker 5x to restore the changed settings illustrated in FIG. 5.

### Second Embodiment

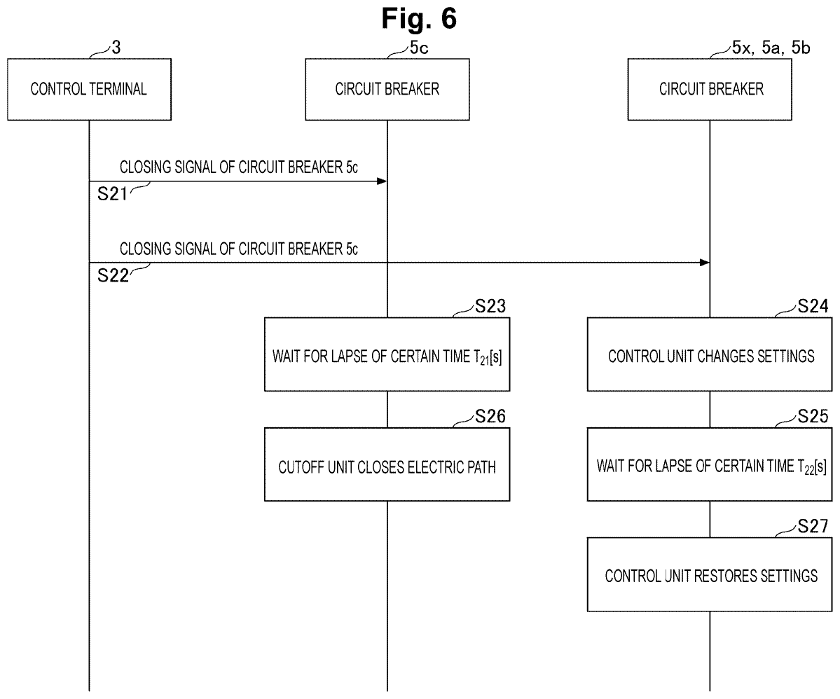

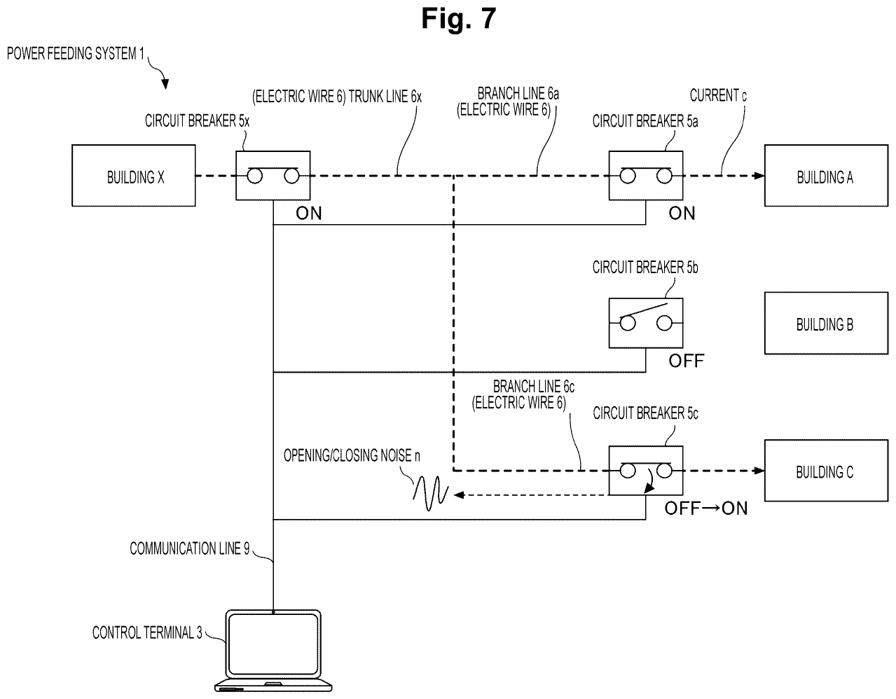

Next, closing of the circuit breaker 5c will be described with reference to FIGS. 5 to 7. FIG. 6 is a sequence diagram illustrating an operation of each circuit breaker in a case where an electric path of the circuit breaker 5c is closed on the basis of a signal from the control terminal according to the second embodiment. FIG. 7 is a conceptual diagram illustrating a situation in which supply of a current c to the building C is started according to the second embodiment. Note that, in the initial state, as illustrated in FIG. 7, the circuit breakers 5x and 5a are in the closed state, and the circuit breakers 5b and 5c are in the open state.

S21: The communication unit 31 of the control terminal 3 transmits a closing signal indicating closing of the circuit breaker 5c (an example of the first circuit breaker) to the circuit breaker 5c via the communication line 9 in response to a command from the control unit 33. As a result, the communication unit 51c receives the closing signal indicating closing of the circuit breaker 5c.

S22: The communication unit 31 of the control terminal 3 transmits a closing signal indicating closing of the circuit breaker 5c to the circuit breakers 5x, 5a, and 5b (examples of the second circuit breaker) via the communication line 9 in response to a command from the control unit 33. As a result, each of the communication units 51x, 51a, and 51b receives the closing signal indicating closing of the circuit breaker 5c.

S23: In the circuit breaker 5c, the control unit 53c receives the closing signal indicating closing of the circuit breaker 5c from the communication unit 51c, and waits for the lapse of a certain time T₂₁[s].

S24: In the circuit breaker 5x, the control unit 53x receives the closing signal indicating closing of the circuit breaker 5c from the communication unit 51x, and changes settings related to the opening operation of the circuit breaker 5x during the certain time T₂₁[s]. The contents of this setting change are similar to those in the first embodiment (see FIG. 5). As a result, the circuit breaker 5x prepares for an opening/closing noise n of the circuit breaker 5c. In addition, the circuit breakers 5a and 5b also perform operation similar to that of the circuit breaker 5x to prepare for the opening/closing noise n of the circuit breaker 5c.

S25: Each of the circuit breakers 5x, 5a, and 5b waits for the lapse of a certain time T₂₂[s].

S26: In the circuit breaker 5c, during the certain time T₂₂[s], the cutoff unit 59c closes (ON) the electric path (contact point) of the branch line 6c in response to the closing signal from the control unit 53c. As a result, as illustrated in FIG. 7, although the opening/closing noise n is generated in the circuit breaker 5c, it is possible to prevent the other circuit breakers 5x, 5a, and 5b from malfunctioning.

S27: In the circuit breaker 5x, the control unit 53x restores the changed settings illustrated in FIG. 5 after the certain time T₂₂[s] elapses. In addition, the circuit breakers 5a and 5c also perform operation similar to that of the circuit breaker 5x to restore the changed settings illustrated in FIG. 5.

### Third Embodiment

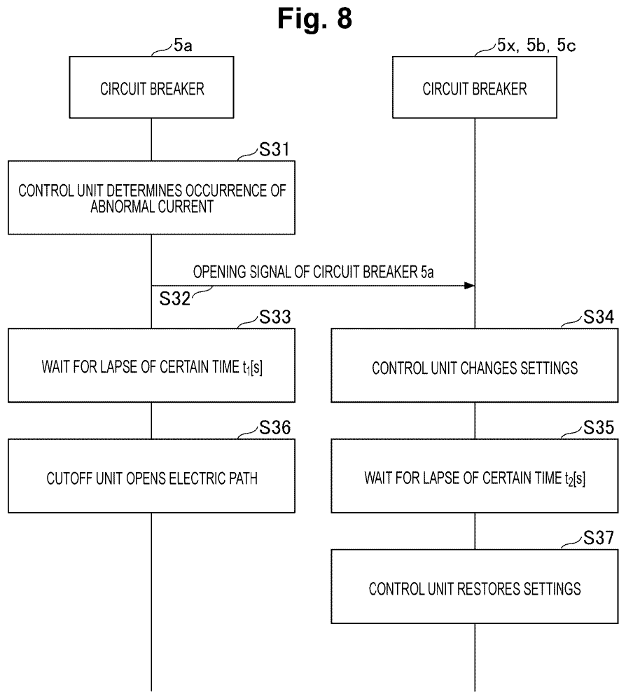

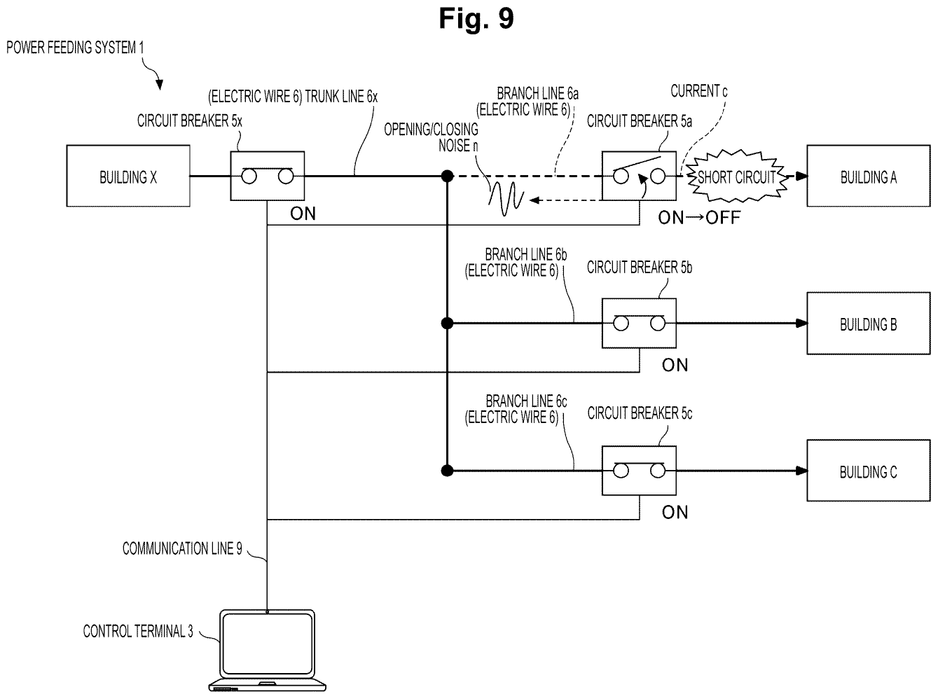

Subsequently, opening of the circuit breaker 5a by detection of an overcurrent (large current) will be described with reference to FIGS. 5, 8, and 9. FIG. 8 is a sequence diagram illustrating operations of the circuit breaker 5a and the other circuit breakers in a case where an electric path of the circuit breaker 5a is opened according to the third embodiment. FIG. 9 is a conceptual diagram illustrating a situation in which a short circuit occurs in the branch line 6a connected to the building A and supply of a current c to the building A is stopped according to the third embodiment. Note that, in the initial state, as illustrated in FIG. 9, all the circuit breakers 5x, 5a, 5b, and 5c are in the closed state.

S31: In the circuit breaker 5a, the measurement unit 57a measures a current value by the current sensor 55a, whereby the control unit 53a detects that an overcurrent (large current) has occurred in the circuit breaker 5a.

S32: The communication unit 51a transmits an opening signal indicating opening of the circuit breaker 5a to the other circuit breakers 5x, 5b, and 5c via the communication line 9 in response to a command from the control unit 53a. As a result, each of the communication units 51x, 51b, and 51c receives the opening signal indicating opening of the circuit breaker 5a.

S33: In the circuit breaker 5a, the control unit 53a waits for the lapse of a certain time t₁[s].

S34: In the circuit breaker 5x, the control unit 53x receives the opening signal indicating opening of the circuit breaker 5a from the communication unit 51x, and changes settings related to the opening operation of the circuit breaker 5x during the certain time T₁[s]. The contents of this setting change are similar to those in the first embodiment (see FIG. 5). As a result, the circuit breaker 5x prepares for an opening/closing noise n of the circuit breaker 5a. In addition, the circuit breakers 5b and 5c also perform operation similar to that of the circuit breaker 5x to prepare for the opening/closing noise n of the circuit breaker 5a.

S35: Each of the circuit breakers 5x, 5b, and 5c waits for the lapse of a certain time t₂[s].

S36: In the circuit breaker 5a, during the certain time t₂[s], the cutoff unit 59a opens (OFF) the electric path (contact point) of the branch line 6a in response to the opening signal from the control unit 53a. As a result, as illustrated in FIG. 9, although the opening/closing noise n is generated in the circuit breaker 5a, it is possible to prevent the other circuit breakers 5x, 5b, and 5c from malfunctioning.

S37: In the circuit breaker 5x, the control unit 53x restores the changed settings illustrated in FIG. 5 after the certain time t₂[s] elapses. In addition, the circuit breakers 5b and 5c also perform operation similar to that of the circuit breaker 5x to restore the changed settings illustrated in FIG. 5.

### Modification

Note that, in the third embodiment, opening of the electric path has been described, but the same applies to closing of the electric path.

For example, there is a situation in which the electric path is closed to connect the circuit breaker 5a to a load on the building A side. In this case, closing information is transmitted in the processing S32, and the cutoff unit 59a closes the electric path in the processing S36.

### Main Effects of Embodiments

As described above, according to the present embodiments, since the individual circuit breakers are configured to be able to communicate with each other, at the time of cutoff of a circuit breaker, the other circuit breakers is notified of the timing of the cutoff in advance, and malfunction due to a noise is prevented by a software measure of invalidating an opening or closing operation for a certain time, or changing settings or the like of a cutoff threshold, an operation time limit, and the number of times of determination. As a result, it is possible to suppress the manufacturing cost of a circuit breaker and achieve a relatively small size.

### REFERENCE SIGNS LIST

1 Power feeding system
3 Control terminal
5, 5a, 5b, 5c, 5x Circuit breaker
6 Electric wire
6a, 6b, 6c Branch line
6x Trunk line
9 Communication line
51, 51a, 51b, 51c, 51d Communication unit
53, 53a, 53b, 53c, 53d Control unit
55, 55a, 55b, 55c, 55d Current sensor
57, 57a, 57b, 57c, 57d Measurement unit
59, 59a, 59b, 59c, 59d Cutoff unit

1. A power feeding system comprising:
a first circuit breaker,
a second circuit breaker, and
a control terminal that remotely controls the first circuit breaker and the second circuit breaker, wherein
the control terminal transmits an opening signal indicating opening of the first circuit breaker to the first circuit breaker and the second circuit breaker,
the first circuit breaker waits for a lapse of a first time on a basis of the opening signal,
the second circuit breaker changes a setting to suppress an opening operation of the second circuit breaker during the first time on a basis of the opening signal and waits for a lapse of a second time,
the first circuit breaker opens an electric path of the first circuit breaker during the second time, and
the second circuit breaker restores the changed setting after the second time elapses.

2. A power feeding system comprising:
a first circuit breaker,
a second circuit breaker, and
a control terminal that remotely controls the first circuit breaker and the second circuit breaker, wherein
the control terminal transmits a closing signal indicating closing of the first circuit breaker to the first circuit breaker and the second circuit breaker,
the first circuit breaker waits for a lapse of a first time on a basis of the closing signal,
the second circuit breaker changes a setting to suppress an opening operation of the second circuit breaker during the first time on a basis of the closing signal and waits for a lapse of a second time,
the first circuit breaker closes an electric path of the first circuit breaker during the second time, and
the second circuit breaker restores the changed setting after the second time elapses.

3-4. (canceled)

5. A cutoff control method performed by a power feeding system including a first circuit breaker, a second circuit breaker, and a control terminal that remotely controls the first circuit breaker and the second circuit breaker, the cutoff control method comprising:
transmitting, by the control terminal, an opening signal indicating opening of the first circuit breaker to the first circuit breaker and the second circuit breaker,
waiting, by the first circuit breaker, for a lapse of a first time on a basis of the opening signal,
changing, by the second circuit breaker, a setting to suppress an opening operation of the second circuit breaker during the first time on a basis of the opening signal and waits for a lapse of a second time,
opening, by the first circuit breaker, an electric path of the first circuit breaker during the second time, and
restoring, by the second circuit breaker, the changed setting after the second time elapses.

6-8. (canceled)
